(19) United States
(12) Patent Application Publication
(10) Pub. No.: US 2021/0139101 A1
(43) Pub. Date: May 13, 2021

(54) A HEATED HAND GRIP FOR A HANDLEBAR OF A VEHICLE

(71) Applicant: OXFORD PRODUCTS LIMITED, Witney, Oxfordshire (GB)

(72) Inventor: Mark Eaton, Oxfordshire (GB)

(21) Appl. No.: 16/476,200

(22) PCT Filed: Jan. 3, 2018
(86) PCT No.: PCT/GB2018/050006

§ 371 Date: Jul. 5, 2019

(30) Foreign Application Priority Data
Jan. 5, 2017 (GB) 1700119.9

(51) Int. Cl. B62K 21/26; B62J 33/00

(52) U.S. Cl. CPC B62K 21/26; B62K 23/02; B62J 33/00

(57) ABSTRACT

A hand grip for a handlebar of a vehicle is disclosed. The grip comprises a first layer and a second layer, the first layer comprising a reduced thermal conductivity compared with the second layer. The first layer comprises a first side which is arranged to extend adjacent at least a portion of the handlebar, and a second side which is opposite the first side. The second layer is disposed over at least a portion of the second side of the first layer, and a heating arrangement for generating heat, is disposed between the first and second layers so that heat generated by the heating arrangement is preferentially transferred to the second layer.

The present invention relates to a hand grip and particularly, but not necessarily exclusively, to a hand grip for a handlebar of a vehicle.

It is well known to provide hand grips on handlebars of vehicles, including dry land vehicles such as bicycles or motorbikes, watercrafts, such as jet-boats, or indeed aerospace vehicles, such as gliders. Known grips may take different forms and sizes and most commonly include a tube made of rubber or other resilient material, which is positioned over one of the handle portions of the handlebar.

During operation of the vehicle the user's hands are typically exposed and as such, the user's hands can become cold. This problem is exacerbated during the winter for example, and can result in a reduced mobility and sensation in the user's hands. These undesired effects are typically alleviated by wearing gloves for example, However, gloves offer only a limited thermal barrier and can also result in a reduced mobility of the user's hands.

We have now devised a hand grip which alleviates at least some of the above problems.

In accordance with a first aspect of the present invention, there is provided a hand grip for a handlebar of a vehicle, the grip comprising:

a first layer and a second layer, the first layer comprising a reduced thermal conductivity compared with the second layer,

the first layer comprising a first side which is arranged to extend adjacent at least a portion of the handlebar, and a second side which is opposite the first side,

the second layer being disposed over at least a portion of the second side of the first layer, and

a heating arrangement for generating heat,

wherein, the heating arrangement is disposed between the first and second layers so that heat generated by the heating arrangement is preferentially transferred to the second layer.

In an embodiment, the grip further comprises a base layer disposed along at least a portion of the first side of the first layer.

In an embodiment, the grip further comprises a plurality of protuberances disposed on an outer surface of the grip. The protuberances extend away from the first layer through corresponding apertures disposed within the second layer.

In an embodiment, the heating arrangement comprises a polyimide film which extends between the first and second layers. It is envisaged that the film may be arranged to line an interface between the first and second layers.

The hand grip further comprises a power source for powering the heating arrangement. In an embodiment, the power source is attachable to the vehicle and may comprise a battery arrangement for example. Alternatively, the power source may comprise a dynamo or similar for example, for powering the heating arrangement during the use thereof.

In an embodiment, the heating arrangement comprises control means for controlling the heating of the grip. The control means may be configured to control a temperature of the heating arrangement and to provide an indication of a temperature of the heating arrangement. The control means may include control buttons disposed on an outer surface of the grip, the buttons being configured to set the temperature of the heating arrangement. The control means may also include a display disposed on the outer surface of the grip for displaying a temperature indication of the heating arrangement.

In an embodiment, the handle grip further comprises a plurality of thermal breaks configured to minimise a passage of heat from the grip to the handlebar. The thermal breaks may comprise a plurality of spacers configured to hold the first layer or base layer for example, in spaced relation to the handlebar. The spacers may be formed integrally with the first layer or base layer, or separately and secured thereto, for example.

In an embodiment, the first layer, second layer and base layer comprise a substantially cylindrical shape. In this case, the first layer is disposed radially inwardly of the second layer and the base layer, if present, is disposed radially inwardly of the first layer. The spacers, if present, extend to the radially innermost region of the handle grip and may comprise rings, for example.

In an embodiment, the second layer comprises an aluminium layer.

In accordance with a second aspect of the present invention, there is provided a vehicle for transporting a user, the vehicle comprising a handlebar having at least one hand grip according to the first aspect disposed upon the handlebar.

Whilst the invention has been described above, it extends to any inventive combination of features set out above or in the following description. Although illustrative embodiments of the invention are described in detail herein with reference to the accompanying drawings, it is to be understood that the invention is not limited to these precise embodiments.

Furthermore, it is contemplated that a particular feature described either individually or as part of an embodiment can be combined with other individually described features, or parts of other embodiments, even if the other features and embodiments make no mention of the particular feature. Thus, the invention extends to such specific combinations not already described.

The invention may be performed in various ways, and, by way of example only, embodiments thereof will now be described with reference to the accompanying drawings, in which:

FIG. 1 is a cross-sectional view of a known hand grip;

FIG. 2 is a cross-sectional view of the hand grip according to an embodiment of the present invention;

FIG. 3 is a perspective view of the hand grip with heating control buttons;

FIG. 4 is a perspective view of the hand grip with a temperature indication display;

FIG. 5 is a front view of the hand grip with an first layer and second layer removed;

FIG. 6 is a perspective view of a vehicle according to an embodiment of the present invention;

Referring to FIG. 1 of the drawings there is illustrated a known grip 100 typically used with motorcycle handlebars. The hand grip comprises a tubular base layer 110, which is made of a plastics material for example, and which is positioned over a handle portion of a handlebar tube 120. At least one end of the grip comprises an annular flange 130 which acts as a stop for a users hand. The grip further comprises an outer tubular section which may be formed of a rubber material for example which contacts the users hand during use, and a heating element 140 disposed at the interface between the base layer and outer layer 150, which is adapted to provide heat to the a user's hand.

Referring to FIG. 2 of the drawings there is illustrated a hand grip 200 according to an embodiment of the present invention. The hand grip 200 may be adapted for use on bicycles or motorcyles, however, it will be apparent to the skilled person that the grip 200 of the present invention may be used with various vehicles and may be positioned over different components of the vehicle, such as metal bars adapted to be held by passengers of a multi-person vehicle, for example.

In an embodiment, the hand grip 200 comprises a substantially cylindrically shaped body 200a having an annular flange 230 disposed at one longitudinal end thereof. The annular flange comprises a diameter which is larger than a diameter of the body 200a and serves as a stop for a user's hand.

The body 200a comprises a base layer 210 having a substantially cylindrical shape, which may be formed of a rigid, moulded material such as plastics material, having an internal diameter which substantially corresponds to an outer diameter of a handle portion of the handlebar 220, such that the base layer 210 forms a friction fit upon the handlebar 220, for example. The body 200a further comprises a first layer 250 having substantially cylindrical shape disposed upon the base layer 210 and a second layer 260 again having a substantially cylindrical shape, disposed upon the first layer 250. The base layer 210, first layer 250 and second layer 260 thus form a nested arrangement of substantially cylindrical layers, with the base layer 210 being disposed radially inwardly of the first layer 250 and the first layer 250 being disposed radially inwardly of the second layer 260.

The first layer 250 comprises a thermal conductivity which is less than a thermal conductivity of the second layer 260. In this respect, the first layer 250 may comprise a substantially thermally insulating material, such as rubber, whereas the second layer 260 may comprise a substantially thermally conducting layer, such as aluminium. The body 200a further comprises a heating arrangement 240 disposed between the first and second layer 250, 260, so that heat generated by the arrangement 240 is preferentially transferred to the second layer 260. The first layer 250 acts to minimise any dissipation of heat from the arrangement to the base layer 210 and thus the handlebar 220. In an embodiment, the heat transfer from the heating arrangement 240 to the handlebar 220 may be further minimised by incorporating one or more thermal breaks into the body 200a of the grip 200. For example, the thermal breaks may comprise annular rings 280 disposed between the base layer 210 and the handlebar 220, so that the base layer 210 is held in spaced relation to the handlebar 220. Alternatively, in situations where the body 200a does not comprise a base layer 210, then the thermal breaks may extend between the first layer 250 and the handlebar 220. The annular rings 280 are spaced along the length of the body 200a and may be formed integrally with the base layer 210, or otherwise formed separately and secured thereto. The annular rings 280 provide a suitable contact between the base layer 210 and the handlebar 220 so that relative movement between the grip 200 and the handlebar 220 is minimised, and further serve to reduce the thermal contact area between the base layer and the handle bar.

The heating arrangement 240 comprises a heating element 241, such as a coil of resistive wire, which is disposed upon a radially outer surface of the first layer 250. In particular, the coil may be wound on the first layer 250 and forms a thermal contact with second layer 260. The heating arrangement 240 may further comprise a polyimide film 242 (as shown in FIG. 5) which may be coated on the element 241 so as to further improve the thermal contact of the element 241 with the second layer 260.

The heating arrangement 240 is controlled via a controller (not shown) which may be communicatively coupled with the heating element 241, such as via a wireless (i.e. Bluetooth®) or wired connection. The controller (not shown) is arranged to receive control signals from a user for effecting a desired temperature of the grip 200, which may be monitored via a thermistor 243 arranged in communication with the controller (not shown). In an embodiment, the controller may comprise a wireless transceiver (not shown) for example, for enabling a user to control a temperature of the grip 200 remotely. In this respect, it is envisaged that control signals may be provided to the controller via an application (not shown) that may be executed on a mobile device (not shown), such as a mobile phone of tablet. The application may be used to remotely manage the temperature of the heating element 241 so that the grip 200 can be heated prior to use of the vehicle, for example.

The controller (not shown) may also be arranged to receive control signals via one or more buttons disposed on the hand grip 200. For example, referring to FIG. 3 of the drawings, the grip 200 may comprise control buttons 244a, 244b disposed on the outer surface thereof, the buttons 244a, 244b being configured to set a temperature of the heating element 241. In particular, the buttons 244a, 244b may be located on the body 200a or the annular flange 230 so that they can be easily operated by a thumb of the user, for example. The buttons 244a, 244b may comprise a first button 244a, which may be coloured red for example, for increasing the temperature, and a second button 244b, which may be coloured blue for example, for decreasing the temperature. The hand grip 200 may further comprise a temperature indication display 245, as illustrated in FIG. 4 of the drawings, disposed on the outer surface of the grip 200, for providing an indication of the current temperature of the heating element 241. The display 245 may comprise a plurality of light-emitting diodes 246 arranged on the body 200a or the annular flange 230.

Typically, a handlebar 220 of a vehicle comprises two handle portions. Accordingly, it is envisaged that one grip 200, may comprise the necessary buttons 244 for controlling the temperature of both grips 200, while the other grip may comprise the display 245 for displaying an indication of the temperature of each grip 200. In this respect, it is envisaged that the controller (not shown) of each grip 200 can communicate directly with each other, such as via a wireless (i.e. Bluetooth®) connection or via a wired connection. However, the skilled reader will recognise that each grip 200 may instead comprise buttons 244 for controlling the temperature of the respective grip and also a display 245 for displaying an indication of the temperature of the respective grip.

The heating arrangement 240 further comprises a power source 247 which is configured to provide electrical power to the heating element 240. The power source 247, which may comprise a battery arrangement, for example, may be attachable to the vehicle and coupled with the heating element 241 via one or more wires 248, as illustrated in FIG. 6 of the drawings. However, it is also envisaged that the heating arrangement 240 may be powered by a dynamo (not shown) for example, which utilises the motion of the vehicle to generate electrical power, or via an electrical power source (not shown) associated with the vehicle.

The second layer 260 of the grip 200 forms the outer surface of the grip body 200a, which the user contacts during use. Accordingly, to improve the tactile feel of the grip 200 and to minimise any slipping of a users hand upon the grip 200, the second layer 260 comprises a plurality of apertures 261 formed therein through which protuberances 251 of the first layer 250 extend. Alternatively, the outer surface of the second layer 260 may comprise a plurality of rubber stickers (not shown) for example, disposed thereon, in spaced relation to each other, to minimise any slipping between the grip and the users hand.

Referring to FIG. 6 of the drawings, during use, the hand grip 200 is positioned over the handle portions of a handlebar 220 of the vehicle and the heating element 241 of each grip 200 may be connected with the power source 247. The temperature of the grips 200 can subsequently be controlled by the user via the control buttons 244a, 244b. For example, to increase the temperature of the grip 200, the user presses button 244a which via a variable resistor (not shown) for example, causes an increase in the supply of electrical current to the heating element 241. The resistive property of the wire coil converts the electrical energy to heat for heating the second layer 260. The distribution of heat across the second layer 260 is further maximised by the polyimide film 242 which substantially lines the interface between the first and second layers 250, 260. The second layer 260, which may comprise an aluminium tube for example, further facilitates the propagation of heat towards the users hand owing to greater the thermal conductivity thereof compared with the first, thermally insulating layer 250. Conversely, if a user wishes to reduce the temperature of the grip 200, then the user presses button 244b which, again via the variable resistor (not shown) reduces the electrical current supplied to the heating element 241 and thus the amount of energy that is converted to heat therein.

From the foregoing therefore, it is evident that the grip according to the present invention provides an improved means for heating the hand of the user while minimising heat loss.

1. A hand grip for a handlebar of a vehicle, the grip comprising:
a first layer and a second layer, the first layer comprising a reduced thermal conductivity compared with the second layer,
the first layer comprising a first side which is arranged to extend adjacent at least a portion of the handlebar, and a second side which is opposite the first side,
the second layer being disposed over at least a portion of the second side of the first layer, and
a heating arrangement for generating heat,
wherein, the heating arrangement is disposed between the first and second layers so that heat generated by the heating arrangement is preferentially transferred to the second layer.

2. A hand grip according to claim 1, further comprising a base layer disposed along at least a portion of the first side of the first layer.

3. A hand grip according to claim 1, further comprising a plurality of protuberances disposed on an outer surface of the grip.

4. A hand grip according to claim 3, wherein the protuberances extend away from the first layer through corresponding apertures disposed within the second layer.

5. A hand grip according to claim 1, wherein the heating arrangement comprises a polyimide film which extends between the first and second layers.

6. A hand grip according to claim 1, further comprising a power source for powering the heating arrangement.

7. A hand grip according to claim 6, wherein the power source is attachable to the vehicle.

8. A hand grip according to claim 6, wherein the power source comprises a battery arrangement.

9. A hand grip according to claim 6, wherein the power source may comprises a dynamo for powering the heating arrangement.

10. A hand grip according to claim 1, wherein the heating arrangement comprises control means for controlling the heating of the grip.

11. A hand grip according to claim 10, wherein the control means is configured to control a temperature of the heating arrangement.

12. A hand grip according to claim 10, wherein the control means is configured to or further configured to provide an indication of a temperature of the heating arrangement.

13. A hand grip according to claim 10, wherein the control means comprises control buttons disposed on an outer surface of the grip, for adjusting a temperature of the heating arrangement.

14. A hand grip according to claim 10, wherein the control means comprises or further comprises a display disposed on the outer surface of the grip for displaying a temperature indication of the heating arrangement.

15. A hand grip according to claim 1, further comprising a plurality of thermal breaks configured to minimise a passage of heat from the grip to the handlebar.

16. A hand grip according to claim 15, wherein the thermal breaks comprise a plurality of spacers configured to hold the first layer or base layer if present, in spaced relation to the handlebar.

17. A hand grip according to claim 2, wherein the first layer, second layer and base layer comprise a substantially cylindrical shape.

18. A hand grip according to claim 17, wherein the first layer is disposed radially inwardly of the second layer and the base layer, is disposed radially inwardly of the first layer.
